(19) United States
(12) Patent Application Publication
(10) Pub. No.: US 2026/0197618 A1
(43) Pub. Date: Jul. 9, 2026

(54) METHODS FOR TRANSMITTING PAI INFORMATION DURING AN EMERGENCY CALL

(71) Applicant: T-MOBILE INNOVATIONS LLC, Overland Park, KS (US)

(72) Inventor: Manikanta Kumar Teja PENUMATSHA, Redmond, WA (US)

(21) Appl. No.: 19/014,802

(22) Filed: Jan. 9, 2025

(51) Int. Cl. H04W 4/90; H04L 65/1104

(52) U.S. Cl. CPC H04W 4/90; H04L 65/1104

(57) ABSTRACT

Methods are provided for initiating an emergency call session between a public safety access point (PSAP) and a wireless device, during which priority asserted identity (PAI) information transmitted with the emergency call may not reach the PSAP, receiving from the PSAP a session initiation protocol (SIP) signaling message containing a request for priority asserted identity (PAI) information, and transmitting the PAI information from the wireless device to the PSAP using a SIP signaling message.

### TECHNICAL BACKGROUND

Cellular phones, such as smartphones, are often used for contacting emergency services. In some instances, the emergency service is contactable by a public safety answering point (PSAP). When an emergency call is made, information including priority asserted identity (PAI) information, such as the callback number for the cellular phone making the emergency call, is transmitted to the PSAP. However, due to the routing of the emergency call, the PAI information may be stripped from the transmission to the PSAP. As a result, the PSAP may be unable to contact the cellular phone in the event of a disconnection between the cellular phone and the PSAP.

### OVERVIEW

Exemplary embodiments described herein include methods for transmitting PAI information during an emergency call. An exemplary method includes initiating an emergency call session between a wireless device and a public safety access point (PSAP). The initiation may comprise an initial transmission between the wireless device and the PSAP, with the initial transmission including initial PAI information that does not reach the PSAP. Once the emergency call session is initiated, the method includes receiving from the PSAP a situation initiation protocol (SIP) signaling message. The SIP signaling message contains a request for PAI information. The method then further includes using a SIP signaling messaging to transmit the PAI from the wireless device to the PSAP using a wireless network.

Another example method includes initiating an emergency call session between a wireless device and a PSAP. The method further includes transmitting a first set of PAI information, by the wireless device, to the PSAP; however, the first set of PAI does not reach the PSAP. The method then includes receiving from the PSAP a SIP signaling message containing a request for a second set of PAI information. Upon receiving the SIP signaling message from the PSAP, the method includes transmitting a second set of PAI information to the PSAP from the wireless device, using a SIP signaling message.

A further example method for transmitting PAI information during an emergency call includes initiating an emergency call session between a wireless device and PSAP. The method then includes transmitting a first set of PAI information to the PSAP by the wireless device. The first set of PAI information is transmitted during initiation of the emergency call session but does not reach the PSAP. The method then includes receiving, from the PSAP, a SIP signaling message containing a request for a second set of PAI information. Upon receiving the SIP signaling message from the PSAP, the method includes transmitting a second set of PAI information from the wireless device to the PSAP, with the second set of PAI information transmitted using a SIP signaling message. The method then includes disconnecting the emergency call session.

### BRIEF DESCRIPTION OF THE DRAWINGS

FIG. 1 illustrates an exemplary system for wireless device communication in accordance with disclosed embodiments.

FIG. 2 illustrates an additional exemplary system for wireless device communication with a PSAP in accordance with disclosed embodiments.

FIG. 3 illustrates an example method for transmitting PAI information during an emergency call in accordance with disclosed embodiments.

FIG. 4 illustrates another example method for transmitting PAI information during an emergency call in accordance with disclosed embodiments.

FIG. 5 illustrates another example method for transmitting PAI information during an emergency call in accordance with disclosed embodiments.

### DETAILED DESCRIPTION

When an emergency call, such as a call to 911, is made, a public safety access point (PSAP) receives the call. The PSAP is connected to a variety of emergency services, such as police, fire, and emergency medical service (EMS), and as such, the PSAP is able to coordinate aid to the caller based on information collected during the emergency call.

When an emergency call is made, whether using long term evolution (LTE), i.e., 4G, or new radio (NR), i.e., 5G, the call is routed through the IP Multimedia Subsystem data channel (IMS DC), ensuring that the call follows a standardized path to reach a PSAP. As part of this path, the call is routed through various nodes of the wireless network, as well as passing through at least one interconnect session border controller (ISBC). An ISBC controls call signaling between the IMS network and external networks. More particularly, for an emergency call, the ISBC acts as the intermediary between the wireless device's IMS network (i.e., the wireless network over which the wireless device is making the emergency call) and the network of the PSAP.

As part of the emergency call, various personal asserted identity (PAI) information, such as a callback number of the wireless device making the emergency call, is transmitted to the PSAP. Upon extracting the PAI information, the PSAP has the necessary information to perform a callback to the wireless device in the event of a disconnect, whether purposeful or accidental, of the emergency call.

As enhanced 911 (E911) services have advanced, additional session border controllers (SBCs) are being deployed across various call handling enhancement (CHE) systems to aid in managing the increased traffic and enhance communication between the PSAP and wireless networks. In addition, PSAP evolution due to, for example, Interoperable Communication Enhancement (ICE), which also includes various CHE systems, has resulted in PSAPs introducing additional ISBCs. As a result, an emergency call between a wireless device and a PSAP is likely to be routed through additional ISBCs and SBCs during transmission of the call.

However, each additional ISBC and SBC (collectively, additional nodes) may be configured separately, resulting in each additional node having distinct privacy rules, network configurations, and/or technical requirements. As a result, as the emergency call, which includes PAI information, is transmitted through the additional nodes, one or more of the additional nodes may strip information from the emergency call. This stripped information may include the PAI information. When the PAI information is stripped, the PSAP may not be able to retrieve a callback number or other identifying information upon receiving the emergency call, thus rendering the PSAP unable to perform a callback to the wireless device if necessary. As a result, if the emergency call is disconnected, the PSAP will be unable to get back into contact with the caller, potentially rendering the caller unable to receive aid in a timely fashion.

In addition, wireless devices other than cellular phones may be able to make emergency calls despite not having a traditional telephone number associated with the device. For example, various over-the-top (OTT) devices may be configured to allow calls to emergency services. However, due to lacking an associated telephone number, the PAI information of an OTT device may not include a callback number, resulting in a PSAP being unable to contact the user if the emergency call made over the OTT device is dropped or otherwise ends.

Exemplary embodiments described herein include methods for transmitting PAI information during an emergency call. For example, during an emergency call, a PSAP may review the information, including the PAI information, that was transmitted as part of the emergency call to ensure that all necessary information, such as a callback number, was successfully received at the PSAP. If the PSAP determines that the PAI information was not received at the PSAP, the PSAP may transmit a message to the wireless device to request PAI information. Once the wireless device receives the message, the wireless device may transmit a response to the PSAP. The response may both acknowledge receipt of the request message and include the requested PAI information. Thus, if the emergency call is disconnected during the call, the PSAP has the necessary information, such as a callback number, to re-establish contact with the caller.

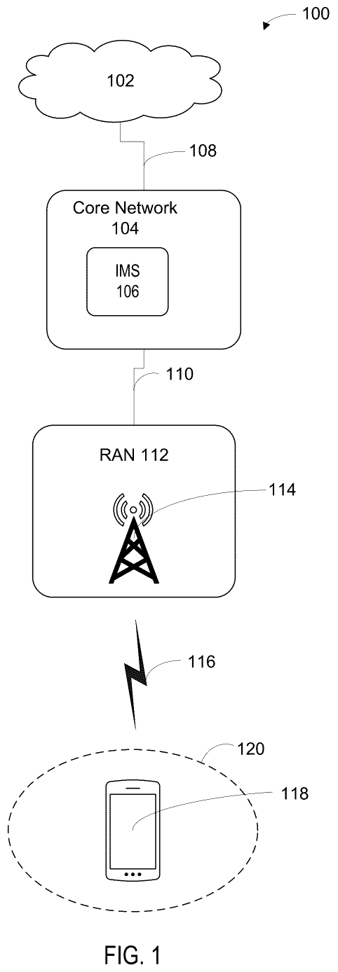

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

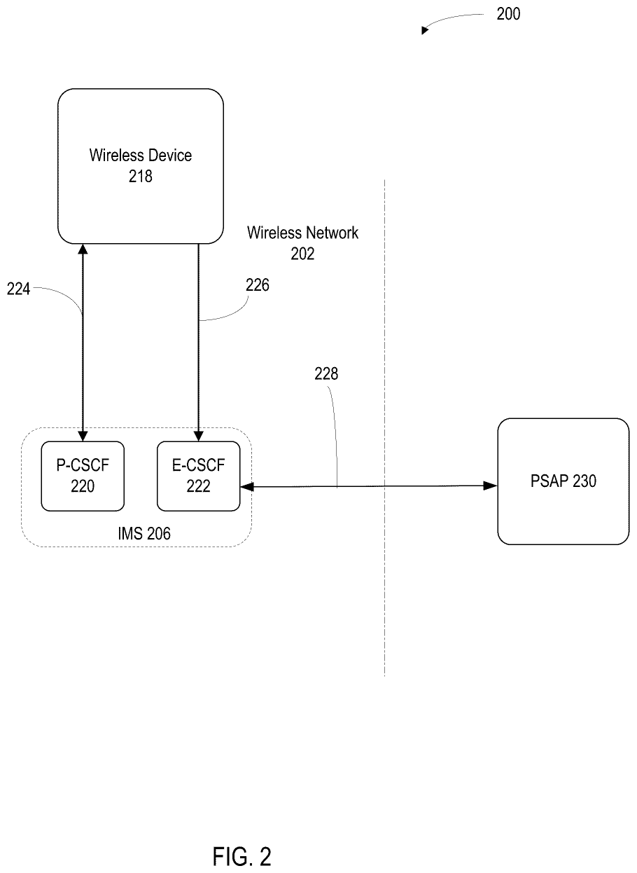

The core network 104 includes the IP Multimedia Subsystem (IMS) 106, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 103 may be used for communication between entities or components of network 102 and wireless device 118. For example, the CSCF of the IMS 106 may be used for transmitting SIP communication to wireless device 118 and a PSAP. Communication links 108 and 110 can use various communication media, such as air, space, metal, optical fiber, or some other signal propagation path-including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. Wireless device 118 may include any device configured to send and receive messages over SIP. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for identifying emergency callback numbers may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for identifying and prioritizing emergency callbacks using SIP is presented. System 200 includes a wireless device 218. Wireless device 218 may be the same as wireless device 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes may include servers, including a proxy call session control function (P-CSCF) 220 and an emergency call session control function (E-CSCF) 222, shown, but it should be understood that there are many other types of IMS and core servers that are omitted for clarity. A proxy server, such as P-CSCF 220 receives a call request from a wireless device, as shown by arrow 224. Headers may be added to the call request in the form of SIP headers such as Resource Priority Header (RPH), X-MAV-RPH: 911, Orig. ID, attestation-Info, and priority asserted identity (PAI) information. The call request may then be forwarded to an emergency call management server such as E-CSCF 222 for further processing, as shown by arrow 226. E-CSCF 222 may query a gateway mobile location center (GMLC) for information about the destination network of the call. The GMLC returns information on a public safety access point (PSAP) 230 that services the location of the wireless device that originated the call request. This information includes how to contact the PSAP 230. The wireless device 218 is then connected to the PSAP 230. However, while the wireless device 218 is connected to the PSAP 230, various information contained in the header, including PAI information, may have been stripped while traveling through the IMS 206. Said differently, during processing of the call request from the wireless device 218 at the P-CSCF 220 and the E-CSCF 222, the PAI information may be stripped from the header, resulting in the call reaching the PSAP 230 but the PAI information in the header to not. In some examples, the PSAP 230 may use SIP trunking to connect to IMS 206, which allows PSAP 230 to send and receive voice and multimedia data over an IP network, as shown by arrow 228. PSAP 230 may use SIP and session description protocol (SDP) for managing session and session parameters.

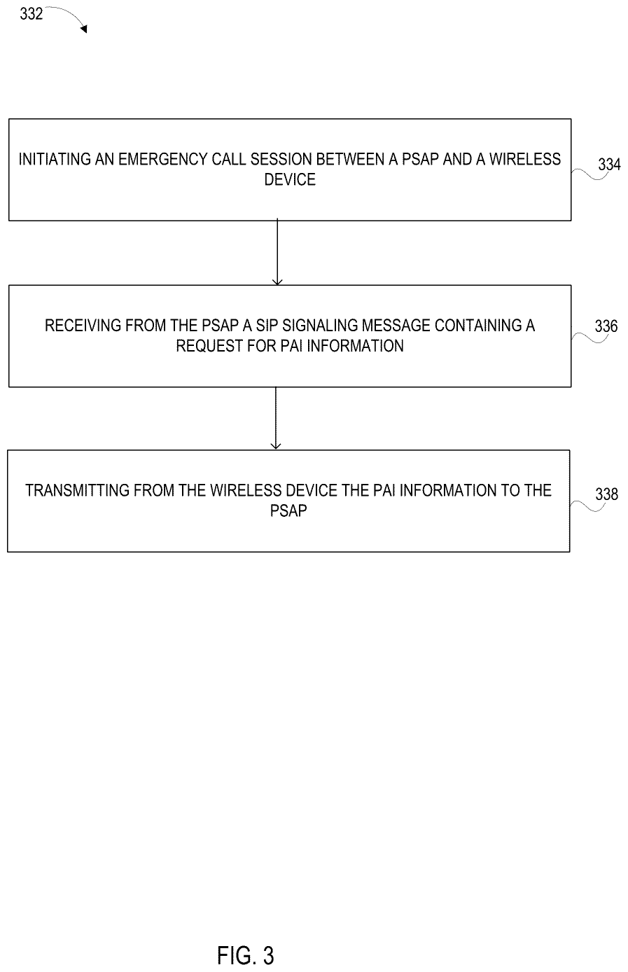

FIG. 3 illustrates an example method 332 for transmitting priority asserted identity (PAI) information during an emergency call. Method 332 may be performed by any suitable combination of processors discussed herein, for example a processor contained in an emergency call management server, such as an E-CSCF server.

Method 332 begins in step 334 where an emergency call session is initiated between a PSAP and a wireless device. The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the PSAP 230 or vice versa. In embodiments, the SIP INVITE may be an initial transmission. In embodiments, the SIP INVITE may include session description protocol (SDP) parameters that establishes an IMS DC for the session. In some examples, initiating the emergency call may include transmitting a callback number of the wireless device to the PSAP. The callback number may be transmitted as part of the SIP INVITE and more particularly may be included within a header of the SIP INVITE during transmission of the SIP INVITE. The callback number may be included with priority asserted identity (PAI) information transmitted within the header of the SIP INVITE during transmission of the SIP INVITE. However, in some examples, the PAI information in the header of the SIP INVITE, including the callback number, may be stripped from the header during initiation of the emergency call session, and more particularly may be stripped during processing of the SIP INVITE at, e.g., the CSCF.

Method 332 continues in step 336 where the wireless device receives, from the PSAP, a SIP signaling message, such as a SIP UPDATE, SIP MESSAGE, OR SIP NOTIFY, containing a request for PAI information. The SIP signaling message is transmitted using an IMS DC. An IMS DC refers to a content-agnostic data transmission tunnel that uses SIP and IP Multimedia Subsystem (IMS) to carry multimedia services over an IP network. In an embodiment, the SIP signaling message may be transmitted by the PSAP 230 to wireless device 218. In some examples, the PSAP may transmit a SIP signaling message that includes SDP with parameters establishing the IMS DC and subsequently may transmit the request for PAI information using the IMS DC. Once the wireless device receives the SIP signaling message, the wireless device may extract the request for PAI information.

The SIP signaling message received from the PSAP at the wireless device at step 336 may include an indication from the PSAP that a callback number of the wireless device was not received as part of the initiation of the emergency call at step 334. More particularly, the SIP signaling message received from the PSAP at the wireless device at step 336 may include an indication that the callback number or additional PAI information was stripped from the header of the initial SIP INVITE. Thus, the SIP signaling message may alert the wireless device both that at least some of the PAI information, such as a callback number, was not successfully transmitted as part of the emergency call initiation, as well as requesting the PAI information from the wireless device.

At step 338, method 332 includes transmitting, using a SIP signaling message, from the wireless device, the PAI information to the PSAP. The SIP signal message may be transmitted by a wireless network, and more particularly may be transmitted using the IMS DC established at step 336 when the wireless device receives a SIP signaling message from the PSAP. In some examples, the PAI information may be included as part of a header of the SIP signaling message transmitted by the wireless device.

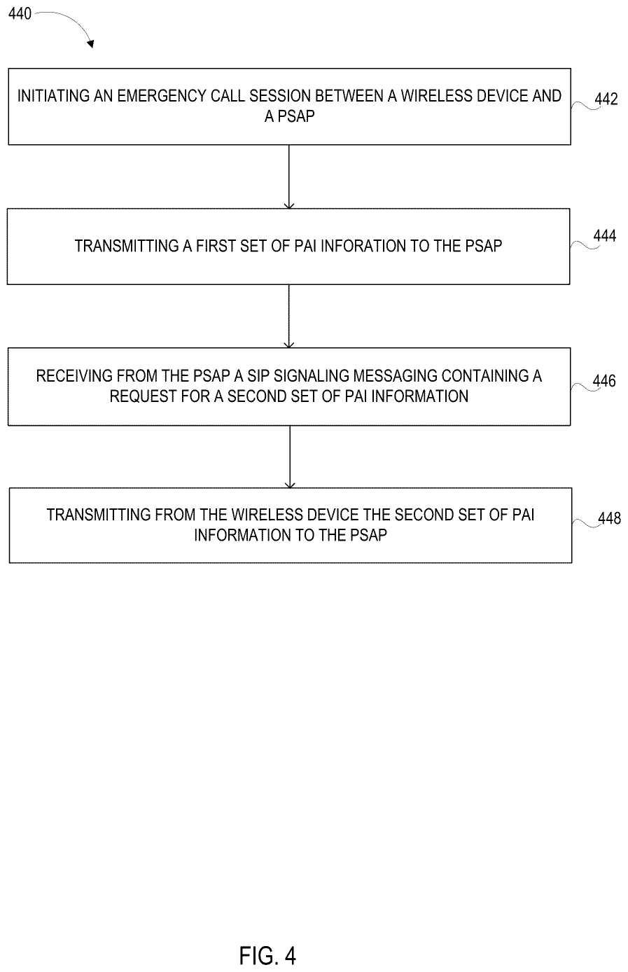

FIG. 4 illustrates another example method 440 for transmitting priority asserted identity (PAI) information during an emergency call in accordance with disclosed embodiments. Method 440 may be performed by any suitable combination of processors discussed herein, for example a processor contained in an emergency call management server, such as an E-CSCF server.

Method 440 begins at step 442 where an emergency call session is initiated between a PSAP and a wireless device. The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the PSAP 230 or vice versa. In embodiments, the SIP INVITE may include session description protocol (SDP) parameters that establishes an IMS DC for the session.

Method 440 continues in step 444 where a first set of PAI information is transmitted to the PSAP by the wireless device. The PAI information may include a callback number for the wireless device; thus, transmitting a first set of PAI information to the PSAP may include transmitting the wireless device callback number to the PSAP. In some examples, the first set of PAI information may be transmitted as part of the initiation of an emergency call session at step 442. In some embodiments, some or all of the first set of PAI information is not received by the PSAP. As such the PSAP sends a SIP signaling message requesting a second set of PAI information, as described further herein.

At step 446, method 440 includes receiving at the wireless device a SIP signaling message from the PSAP, where the SIP signaling message contains a request for a second set of PAI information. The SIP signaling message is transmitted using an IMS DC. In some examples, the PSAP may transmit a SIP signaling message that includes SDP with parameters establishing the IMS DC and subsequently may transmit the request for a second set of PAI information using the IMS DC. The header of the SIP signaling message may include the request for a second set of PAI information. Once the wireless device receives the SIP signaling message, the wireless device may extract the request from the header.

In some examples, the SIP signaling message may include a notification that the PSAP did not receive the first set of PAI information transmitted by the wireless device at step 444. In examples where the wireless device is a cellular phone, such as a smartphone, the notification of non-receipt of the first set of PAI information at the PSAP may indicate that the PAI information was stripped at a node during processing of the call initiated at step 442. However, in some examples, the wireless device may be an over-the-top (OTT) device. In examples where the wireless device is an OTT device, the wireless device may not include directly associated PAI information; thus, a notification of non-receipt of the first PAI information at the PSAP may be a result of the emergency call being initiated at step 442 by an OTT device.

At step 446, method 440 includes transmitting a second set of PAI information from the wireless device to the PSAP. The second set of PAI information may be transmitted using a SIP signaling message and may be transmitted via the established IMS DC. In some examples, the second set of PAI information may include a callback number of the wireless device. In examples where the wireless device is a cellular phone, the callback number may be the direct callback number of the wireless device. However, as described previously, OTT devices may be used to initiate an emergency call session, despite the OTT device lacking a direct callback number. Thus, in examples where an OTT device was used to initiate the emergency call session at step 442, the PAI information transmitted from the wireless device to the PSAP at step 446 may include transmitting a callback number that is associated with the OTT device. For example, in situations where a device such as a tablet is used to initiate the emergency call session at step 442, the tablet may be associated with a cellular phone by, for instance, appearing on a user account together. Thus, the second set of PAI information transmitted at step 448 may include transmitting the callback number for the associated cellular phone, even with the emergency call originating at the tablet.

In some examples, transmitting the second set of PAI information to the PSAP at step 448 may include using the wireless device to transmit a confirmation of receipt of the SIP signaling message. In some examples, the confirmation of receipt may be a 200 OK message transmitted from the wireless device to the PSAP. The second set of PAI information may be included within a header of the confirmation of receipt message. Thus, the wireless device may transmit both the confirmation of receipt and the requested second set of PAI information using a single SIP signaling message.

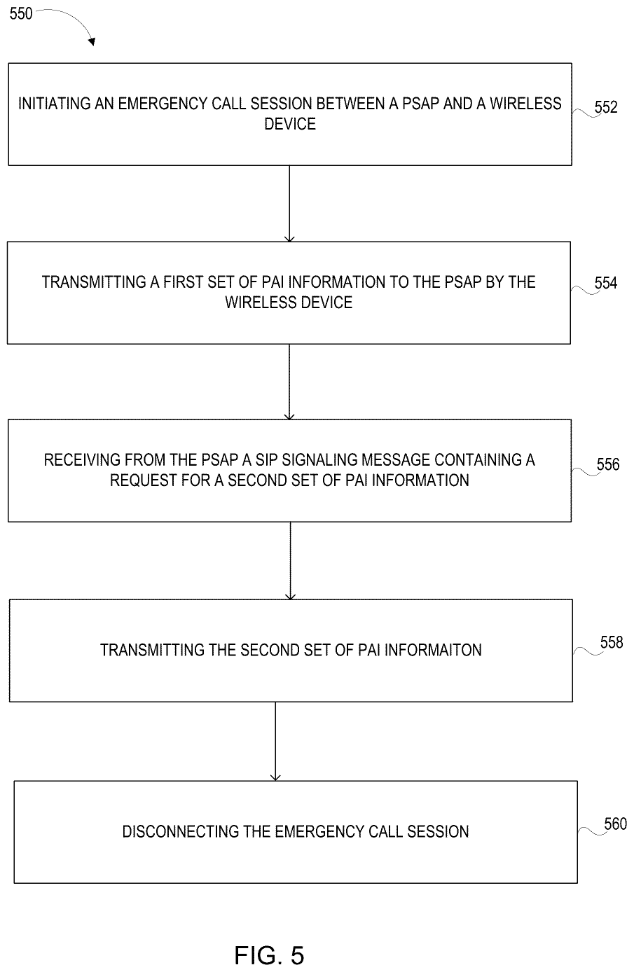

FIG. 5 illustrates another example method 550 for transmitting PAI information during an emergency call in accordance with disclosed embodiments. Method 550 may be performed by any suitable combination of processors discussed herein, for example a processor contained in an emergency call management server, such as an E-CSCF server.

Method 550 begins in step 552 by initiating an emergency call session between a PSAP and a wireless device. The emergency call session may be transmitted via a wireless network, which may be hosted by a mobile network operation (MNO). In some examples, the emergency call is in a session initiation protocol (SIP) invite. In embodiments, the CSCF transmits an SIP INVITE from the wireless device 218 to the PSAP 230 or vice versa. In some examples, the SIP INVITE includes session description protocol (SDP) parameters which establish an IMS DC for the session.

At step 554, method 550 includes transmitting a first set of PAI information to the PSAP by the wireless device. The first set of PAI information may be transmitted during initiation of the emergency call session at step 552 and may include a wireless device callback number. In examples where the emergency call is in a SIP invite, the first set of PAI information may be transmitted as part of a SIP INVITE and more particularly may be transmitted as part of a header of the SIP INVITE. In examples where the first set of PAI information is transmitted as part of a head of a SIP INVITE, some or all of the first set of PAI information may be stripped from the header during processing of the SIP INVITE, resulting in the PSAP requesting a second set of PAI information as described herein.

Method 550 continues at step 556 with receiving, at the wireless device, a SIP signaling message from the PSAP. The SIP signaling message includes a request for a second set of PAI information from the wireless device. In some examples, the PSAP may transmit a SIP signaling message that includes SDP with parameters establishing the IMS DC and subsequently may transmit the request for a second set of PAI information using the IMS DC. The header of the SIP signaling message may include the request for a second set of PAI information. Once the wireless device receives the SIP signaling message, the wireless device may extract the request from the header. In some examples, the SIP signaling message may further include an indication that the first set of PAI information was not successfully retrieved by the PSAP.

At 558, method 550 includes transmitting the second set of PAI information from the wireless device to the PSAP using a wireless network. The second set of PAI information may be transmitted using a SIP signaling message and may be transmitted in response to receiving the request for a second set of PAI information from the PSAP at step 556. In some examples, the second PAI information may include a wireless device callback number. The second PAI information may be included as part of a header of the SIP signaling message. In some examples, the SIP signaling message may be transmitted via the previously established IMS DC.

In some examples, transmitting the second set of PAI information to the PSAP from the wireless device may include transmitting a SIP signaling message indicating receipt of the request from the PSAP at step 556. In such examples, the second set of PAI information may be included within the header of the message confirming receipt of the request from the PSAP. The message indicating receipt of the request, or confirming the request, may be a 200 OK message transmitted form the wireless device to the PSAP, although examples are not so limited and other confirmation formats may be used.

At step 560, method 550 includes disconnecting the emergency call session. In some examples, the emergency call session may be disconnected by the wireless device user or may be disconnected at the PSA, with such disconnection being inadvertent. In other examples, the wireless device user may purposely disconnect the call prior to the PSAP operator being finished gathering information. In still other examples, the disconnection of the emergency call session may occur as a result of a lack of coverage of the wireless network and thus an inability to maintain the emergency call session. For example, if the caller is in motion when the emergency call is initiated at step 552, the caller may move into an area with poor cellular data signal, hampering the ability of the wireless device to maintain the call and resulting in disconnection of the emergency call session.

Method 550 may further include receiving a callback from the PSAP. The call may be received after the emergency call session is ended at step 560. In some examples, the call may be received at the wireless device and may be transmitted via a wireless network. The PSAP may use the second PAI information, transmitted at step 558, to make the callback. More particularly, the PSAP may use the callback number transmitted as part of the second PAI information to call the wireless device, thus re-establishing the emergency call session after the disconnection at step 560.

In some embodiments, methods 332, 440 and 550 may include additional steps or operations. Furthermore, the methods may include steps shown in each of the other methods. As one of ordinary skill in the art would understand, the methods of 332, 440 and 550 may be integrated in any useful manner and the steps may be performed in any useful sequence.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
initiating an emergency call session between a wireless device and a public safety access point (PSAP);
receiving from the PSAP a session initiation protocol (SIP) signaling message containing a request for priority asserted identity (PAI) information; and
transmitting using a SIP signaling message, from the wireless device, the PAI information to the PSAP using a wireless network.

2. The method of claim 1, wherein initiating an emergency call session between a wireless device and a PSAP comprises an initial transmission, wherein initial PAI information including a callback number is stripped from the initial transmission.

3. The method of claim 2, wherein receiving a SIP signaling message from the PSAP includes receiving an indication that the callback number was not received at the PSAP.

4. The method of claim 1, wherein transmitting the PAI information to the PSAP further comprises transmitting the PAI information as part of a confirmation of receipt of the SIP signaling message.

5. The method of claim 1, wherein transmitting the PAI information to the PSAP comprises transmitting the PAI information as part of a header of a SIP signaling message.

6. The method of claim 1, wherein the SIP signaling message is received and transmitted via an IP multimedia subsystem data channel (IMS DC).

7. A method, comprising:
initiating an emergency call session between a wireless device and a public safety access point (PSAP);
transmitting a first set of priority asserted identity (PAI) information to the PSAP by the wireless device, wherein the first set of PAI does not reach the PSAP;
receiving from the PSAP a session initiation protocol (SIP) signaling message containing a request for a second set of PAI information; and
transmitting, using a SIP signaling message, from the wireless device, the second set of PAI information to the PSAP using a wireless network.

8. The method of claim 7, wherein transmitting the first set of PAI information to the PSAP comprises transmitting a wireless device callback number to the PSAP.

9. The method of claim 7, wherein receiving the request for a second set of PAI information further comprises receiving a notification that the first set of PAI information was not transmitted to the PSAP.

10. The method of claim 7, wherein transmitting the second PAI information to the PSAP comprises transmitting the PAI information as part of a confirmation of receipt of the SIP signaling message from the PSAP.

11. The method of claim 10, wherein the PAI information is included in a header of the confirmation of receipt.

12. The method of claim 7, wherein the wireless device is an over the top (OTT) device.

13. The method of claim 12, wherein transmitting the second PAI information comprises transmitting a callback number associated with the OTT device.

14. The method of claim 7, wherein the SIP signaling message is received and transmitted via an IP multimedia subsystem data channel (IMS DC).

15. A method, comprising:
initiating an emergency call session between a wireless device and a public safety access point (PSAP);
transmitting a first set of priority asserted identity (PAI) information to the PSAP by the wireless device, wherein the first set of PAI is transmitted during initiation of the emergency call session and does not reach the PSAP;
receiving from the PSAP a session initiation protocol (SIP) signaling message containing a request for a second set of PAI information;
transmitting, using a SIP signaling message, from the wireless device, the second set of PAI information to the PSAP using a wireless network; and
disconnecting the emergency call session.

16. The method of claim 15, further comprising receiving, at the wireless device, a callback from the PSAP using the second PAI information.

17. The method of claim 16, wherein the second PAI information comprises a wireless device callback number.

18. The method of claim 15, wherein the second PAI information is transmitted to the PSAP in a SIP signaling message indicating receipt of the request from the PSAP.

19. The method of claim 15, wherein the first set of PAI information is transmitted via the wireless network.

20. The method of claim 15, wherein the SIP signaling message is received and transmitted via an IP multimedia subsystem data channel (IMS DC).
